(19) United States
(12) Patent Application Publication
(10) Pub. No.: US 2025/0254620 A1
(43) Pub. Date: Aug. 7, 2025

(54) INDICATION METHOD AND APPARATUS FOR DELAYED WAKE-UP TERMINAL, AND DEVICE

(71) Applicant: VIVO MOBILE COMMUNICATION CO., LTD., Dongguan (CN)

(72) Inventors: Dongru LI, Dongguan (CN); Xueming PAN, Dongguan (CN)

(73) Assignee: VIVO MOBILE COMMUNICATION CO., LTD., Dongguan (CN)

(21) Appl. No.: 19/189,209

(22) Filed: Apr. 24, 2025

Related U.S. Application Data
(63) Continuation of application No. PCT/CN2023/125559, filed on Oct. 20, 2023.

(30) Foreign Application Priority Data
Oct. 27, 2022 (CN) 202211339963.5

(51) Int. Cl. H04W 52/02

(52) U.S. Cl. CPC H04W 52/0235; H04W 52/0274

(57) ABSTRACT

An indication method and apparatus for a delayed wake-up terminal and a device are provided. The indication method includes: obtaining, by a terminal, first indication information; and determining, by the terminal, a first time interval based on the first indication information. The first time interval is any one of the following: a time interval allowed from a time when the terminal monitors a wake-up signal to a time when the terminal is able to monitor a first object; or a time interval allowed from a time when the terminal determines to start monitoring the first object to a time when the terminal is able to monitor the first object. The first object is a channel or a signal other than the wake-up signal.

### CROSS-REFERENCE TO RELATED APPLICATIONS

This application is a continuation of International Application No. PCT/CN 2023/125559, filed Oct. 20, 2023, which claims priority to Chinese Patent Application No. 202211339963.5, filed Oct. 27, 2022. The entire contents of each of the above-referenced applications are expressly incorporated herein by reference.

### TECHNICAL FIELD

This application relates to the field of communication technologies, and in particular, to an indication method and apparatus for a delayed wake-up terminal, and a device.

### BACKGROUND

In existing mobile communication, to achieve power saving of a terminal, a network configures Discontinuous Reception (DRX) or dynamically instructs the terminal to skip monitoring of a Physical Downlink Control Channel (PDCCH) for a period of time. Within the time period for which the monitoring of the PDCCH is skipped, the terminal may enter different sleep states based on a next time point at which a state in which the PDCCH is monitored is returned. In addition, the terminal has a longer delay to return to a state in which the PDCCH is monitored is returned in a deeper sleep state.

However, in a case that the next time point at which a state in which the PDCCH is monitored is returned is not clear, the terminal cannot determine which power-saving mode to enter, causing the terminal to be unable to efficiently save power to ensure service transmission in this case.

### SUMMARY

Embodiments of this application provide an indication method and apparatus for a delayed wake-up terminal, and a device.

According to a first aspect, an indication method for a delayed wake-up terminal is provided, including:
obtaining, by a terminal, first indication information; and
determining, by the terminal, a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a second aspect, an indication apparatus for a delayed wake-up terminal is provided, including:
an obtaining module, configured to obtain first indication information; and
a processing module, configured to determine a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a third aspect, an indication method for a delayed wake-up terminal is provided, including:
sending, by a network side device, first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a fourth aspect, an indication apparatus for a delayed wake-up terminal is provided, including:
a sending module, configured to send first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a fifth aspect, a terminal is provided. The terminal includes a processor and a memory. The memory stores a program or an instruction executable in the processor. The program or the instruction, when executed by the processor, implements the steps of the method in the first aspect.

According to a sixth aspect, a terminal is provided, including a processor and a communication interface. The communication interface is configured to obtain first indication information. The processor is configured to determine a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a seventh aspect, a network side device is provided. The network side device includes a processor and a memory. The memory stores a program or an instruction executable in the processor. The program or the instruction, when executed by the processor, implements the steps of the method in the third aspect.

According to an eighth aspect, a network side device is provided, including a processor and a communication interface. The communication interface is configured to send first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

According to a ninth aspect, an indication system for a delayed wake-up terminal, including a terminal and a network side device. The terminal may be configured to perform steps of the indication method for a delayed wake-up terminal in the first aspect, and the network side device may be configured to perform steps of the indication method for a delayed wake-up terminal in the third aspect.

According to a tenth aspect, a readable storage medium is provided. The readable storage medium stores a program or an instruction. The program or the instruction, when executed by a processor, implement the steps of the method in the first aspect or implement the steps of the method in the third aspect.

According to an eleventh aspect, a chip is provided. The chip includes a processor and a communication interface. The communication interface is coupled to the processor. The processor is configured to execute a program or instructions to implement the method in the first aspect or implement the method in the third aspect.

According to a twelfth aspect, a computer program/program product is provided. The computer program/program product is stored in a storage medium. The computer program/program product is executed by at least one processor to implement the steps of the method in the first aspect, or implement the steps of the method in the third aspect.

In this embodiment of this application, the terminal can determine, by obtaining the first indication information, the time interval allowed from a time when a terminal monitors a wake-up signal to a time when the terminal is able to monitor a first object, or determine the time interval allowed from a time when the terminal determines to start monitoring the first object to a time when the terminal is able to monitor the first object, so that the terminal implements adaptive power saving of the terminal based on a value of the foregoing first time interval.

### BRIEF DESCRIPTION OF THE DRAWINGS

FIG. 1 is a block diagram of a wireless communication system;

FIG. 2 is a schematic diagram of a low power receiver;

FIG. 3 is a schematic diagram I of an indication method for a delayed wake-up terminal according to an embodiment of this application;

FIG. 4 is a schematic diagram II of an indication method for a delayed wake-up terminal according to an embodiment of this application;

FIG. 5 is a schematic diagram I of modules of an indication apparatus for a delayed wake-up terminal according to an embodiment of this application;

FIG. 6 is a schematic diagram II of modules of an indication apparatus for a delayed wake-up terminal according to an embodiment of this application;

FIG. 7 is a schematic structural diagram of a communication device according to an embodiment of this application;

FIG. 8 is a schematic structural diagram of a terminal according to an embodiment of this application; and

FIG. 9 is a schematic structural diagram of a network side device according to an embodiment of this application.

### DETAILED DESCRIPTION

Technical solutions in embodiments of this application are clearly described below with reference to drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in the specification and the claims of this application are used for distinguishing between similar objects, rather than describing a specific sequence or order. It should be understood that the terms used in this case may be transposed where appropriate, so that embodiments of this application may be implemented in a sequence other than those illustrated or described herein. In addition, object items defined by “first” and “second” are generally of the same class and do not limit a quantity of object items. For example, one first object may be arranged, or a plurality of object items may be arranged. In addition, “and/or” used in the specification and the claims indicates at least one of connected object items. The character “/” generally indicates an “or” relationship between associated object items.

It should be noted that the technology described in embodiments of this application may be applied to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. Terms “system” and “network” in embodiments of this application are usually interchangeably used, and the described technology may be used for both the system and the radio technology mentioned above, or may be used for another system and another radio technology. A New Radio (NR) system is described below for an illustrative purpose, and the term NR is used in most of the following descriptions, although the technologies may be applied to applications other than applications of the NR system, such as a 6^{th} Generation (6G) communication system.

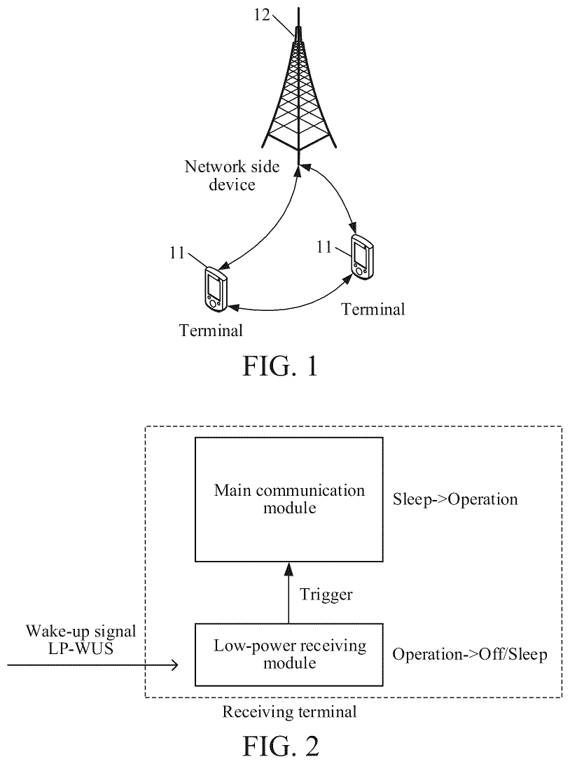

FIG. 1 is a block diagram of a wireless communication system to which an embodiment of this application may be applied. The wireless communication system includes a terminal 11 and a network side device 12. The terminal 11 may be a terminal side device such as a mobile phone, a tablet computer, a laptop computer, which is also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, an on-board device (Vehicle User Equipment, VUE), a Pedestrian User Equipment (PUE), a smart home appliance (a home device with a wireless communication capability, such as a refrigerator, a television, a washing machine, or furniture), a game console, a Personal Computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle, a smart ankle chain, and the like), a smart wristband, smart clothing, and the like. It should be noted that a specific type of the terminal 11 is not limited in this embodiment of this application. The network side device 12 may include an access network device or a core network device. The access network device may also be referred to as a wireless access network device, a Radio Access Network (RAN), a wireless access network function, or a wireless access network unit. The access network device may include a base station, a Wireless Local Area Networks (WLAN) access point, a Wi-Fi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a household NodeB, a household evolved NodeB, a Transmitting Receiving Point (TRP), or some other appropriate term in the field, as long as the same technical effect is achieved. The base station is not limited to a specific technical term. It should be noted that in this embodiment of this application, only a base station in the NR system is used as an example, and a specific type of the base station is not limited.

For ease of understanding, some contents in embodiments of this application are described below.

### I. Low Power Receiver

A low power receiver is a low power wake-up receiver. A basic working principle of the low power receiver is that a receiving end includes a first module and a second module. In some embodiments, as shown in FIG. 2, the first module is a main communication module configured to send and receive mobile communication data. The second module is a low-power receiving module (also referred to as a low power wake-up receiving module) configured to receive a wake-up signal, which is also referred to as a low-power wake-up signal (Low Power Wake up Radio, LP-WUR). A terminal in a power saving state turns on the low-power receiving module to monitor the LP-WUR, and turns off the main communication module. When downlink data arrives, a network side device sends the wake-up signal to the terminal. After monitoring the wake-up signal through the low-power receiving module, the terminal triggers, through a series of determining, the main communication module to switch from an off state to an on state. In this case, the low-power receiving module enters an off state from an operating state. The low power wake-up receiving module may be continuously or discontinuously enabled. When enabled, the low power wake-up receiving module may receive the low-power wake-up signal.

### II. Low-Power Wake-Up Signal

To reduce reception activity of a terminal in a standby state and truly disable a Radio Frequency (RF) module and a baseband modem (MODEM) module, thereby significantly reducing power consumption of communication reception, a receiver (a low-power receiving module in FIG. 2) with near-“zero” power may be provided in a receiving module of the terminal. The receiver with near-“zero” power does not require complex signal detection (such as amplification, filtering, and quantization) of the RF module and signal processing of the MODEM module, but only relies on passive matched filtering and signal processing with low power consumption.

On a base station side, a wake-up signal is triggered on demand, so that the receiver with near-“zero” power can be activated to learn of an activated notification, to trigger a series of processes in the terminal, for example, turning on a radio frequency transceiver module, a baseband processing module, and the like.

The wake-up signal is usually some simple on-off keying signals. In this way, the receiver can learn of a wake-up notification through simple power detection and subsequent possible processes such as sequence detection and recognition. In addition, when the terminal turns on the low power wake-up receiver to receive the wake-up signal, a main receiver module may maintain operating at a relatively low power consumption level, thereby achieving power consumption saving by receiving the wake-up signal.

An indication method for a delayed wake-up terminal provided in embodiments of this application is described below in detail through some embodiments and application scenarios thereof with reference to the drawings.

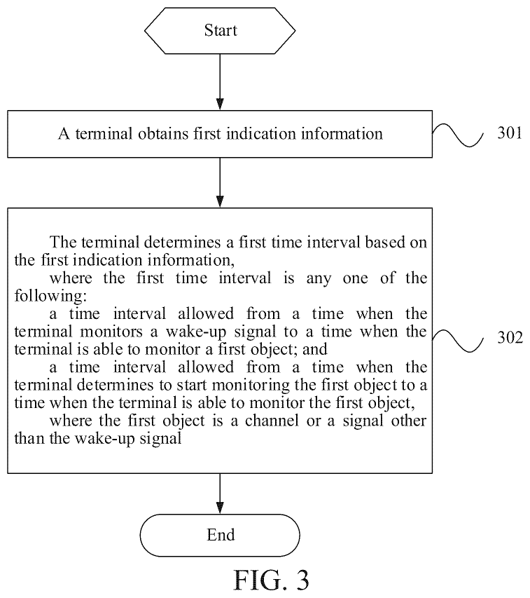

As shown in FIG. 3, an indication method for a delayed wake-up terminal in an embodiment of this application includes the following steps.

Step 301: A terminal obtains first indication information.

The first indication information is used for indicating a first time interval. In addition, the first indication information may be indicated by a network side device, or may be predefined. If the first indication information may be indicated by the network side device, step 301 is that the terminal obtains the first indication information sent by the network side device. If the first indication information may be predefined, step 301 is that the terminal obtains the first indication information stored locally.

Step 302: The terminal determines a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where the first object is a channel or a signal other than the wake-up signal.

That the terminal is able to monitor a first object means that the terminal is well prepared to monitor the first object, or the terminal already meets a condition for monitoring the first object.

In this way, through the foregoing steps, the terminal can determine the first time interval (the time interval allowed from the time when the terminal monitors the wake-up signal to the time when the terminal is able to monitor the first object, or the time interval allowed from the time when the terminal determines to start monitoring the first object to the time when the terminal is able to monitor the first object) by obtaining the first indication information, so that the terminal implements adaptive power saving of the terminal based on a value of the first time interval.

In some embodiments, the terminal can monitor the first object. In other words, in this case, the terminal has a capability of monitoring the first object, and is monitoring the first object, but the terminal does not necessarily monitor the first object.

In some embodiments, the first time interval may be: a time interval from a time when the terminal does not monitor the first object to a time when the terminal is able to monitor the first object, or a maximum time interval from a time when the terminal does not monitor the first object to a time when the terminal is able to monitor the first object.

In some embodiments, the method further includes the following step.

The terminal determines, based on the first time interval, a power-saving mode which the terminal enters during the skipping duration of first object monitoring, where the power-saving mode is related to power consumption of the terminal.

In other words, the first time interval can be used to determine the power-saving mode which the terminal enters during the skipping duration of first object monitoring. Therefore, the terminal can enter a corresponding power-saving mode based on the first time interval indicated by the first indication information, to implement adaptive power-saving of the terminal.

In this embodiment, the power-saving mode may also be a sleep mode (or a state).

In an embodiment, different sleep modes of the terminal present different degrees of power saving. For example:
1) Deep sleep mode: Compared with the other two sleep modes, in this sleep mode, the terminal is more power-saving, but needs a longer time to return to a state in which the terminal is able to monitor the first object, for example, 10 ms.
2) Light sleep mode: In this sleep mode, the terminal consumes more power than entering the deep sleep mode, saves more power than entering the micro sleep mode, and a moderate time to return to a state in which the terminal is able to monitor the first object, for example, 3 ms.
3) Micro sleep mode: Compared with the other two sleep modes, in this sleep mode, the terminal is more power-consuming, but needs a shorter time to return to a state in which the terminal is able to monitor the first object, for example, 0.

The time to return to a state in which the terminal is able to monitor the first object may be understood as a time from a time when the terminal does not monitor the first object to a time when the terminal is able to monitor the first object.

In an embodiment, the first object is a PDCCH.

In some embodiments, a value of the first time interval is configured or predefined by a network side.

In this way, with different values of the first time interval, the terminal may enter different power-saving modes through implementation. In other words, the terminal may implement different power consumption based on the first time interval during a period for which the wake-up signal is monitored or during a period for which the monitoring of the first object is skipped.

In some embodiments, values of the first time interval include at least two of a first value, a second value, and a third value, and the first value, the second value, and the third value are all different.

The first value, the second value, and the third value herein may respectively correspond to the foregoing different sleep modes. Therefore, in a case that the first indication information indicates that the value of the first time interval is one of the first value, the second value, or the third value, the terminal enters the sleep mode corresponding to the value of the first time interval indicated by the first indication information during the time period (that is, the time period for which the monitoring of the first object is skipped, or the time period for which the first object is not monitored) for which the monitoring of the first object is skipped.

In an implementation, a first power consumption is less than a second power consumption and less than a third power consumption. The first power consumption is a conversion power consumption for the terminal to return, based on the first value, to the operating state in which the first object is monitored. The second power consumption is a conversion power consumption for the terminal to return, based on the second value, to the operating state in which the first object is monitored. The third power consumption is a conversion power consumption for the terminal to return, based on the third value, to the operating state in which the first object is monitored.

In this way, based on the foregoing three sleep modes, the first value may be 0 ms, the second value may be 3 ms, and the third value may be 10 ms. When the value of the first time interval determined by the terminal is 3 ms, the terminal may enter the light sleep mode during the time period for which the first object is not monitored, thereby ensuring that a period from a time when the terminal does not monitor the first object to a time of returning to a state in which the terminal is able to monitor the first object does not exceed 3 ms.

The value of the first time interval is not limited to at least two of the first value, the second value, and the third value, and may be only one, or may be three or more. However, there is only one value of the first time interval indicated by the first indication information to the terminal.

In an implementation, the first time interval is a maximum time interval allowed from a time when a terminal monitors a wake-up signal to a time when the terminal is able to monitor a first object, or a maximum time interval allowed from a time when the terminal determines to start monitoring the first object to a time when the terminal is able to monitor the first object.

In other words, a time interval from a time when the wake-up signal is monitored to a time when the terminal is able to monitor the first object, or a time interval from a time when the terminal determines to start monitoring the first object to a time when the terminal is able to monitor the first object needs to meet the indicated first time interval.

It may be understood that, as long as the terminal meets a time interval from a time when the wake-up signal is monitored to a time when the terminal is able to monitor the first object, or a time interval from a time when the terminal determines to start monitoring the first object to a time when the terminal is able to monitor the first object does not exceed the first time interval, which sleep mode or power-saving mode the terminal enters depends on a terminal implementation. In other words, the value of the first time interval indicated by the first indication information may be different from a value of the first time interval indicated by the terminal application. The value of the first time interval indicated by the terminal application is less than or equal to the value of the first time interval indicated by the first indication information. For example, in the foregoing example, another terminal implementation is that after the terminal receives the first time interval indication (indicating 3 ms), the terminal may still select to enter the micro sleep mode instead of entering the light sleep mode within the time period for which the first object is not monitored. In the micro sleep mode, the value of the first time interval applied by the terminal is less than 3 ms.

In some embodiments, the wake-up signal is used for triggering the terminal to start monitoring the first object, or the wake-up signal is used for indicating whether the terminal starts monitoring the first object.

In other words, if the wake-up signal is used for triggering the terminal to start monitoring the first object, the terminal starts monitoring the first object when receiving the wake-up signal. If the wake-up signal is used for indicating whether the terminal starts monitoring the first object, the terminal receives the wake-up signal. The wake-up signal starts monitoring the first object only when the wake-up signal instructs the terminal to start monitoring the first object.

In an implementation, the terminal starts monitoring the first object based on an indication of a monitored wake-up signal.

In some embodiments, the terminal does not monitor the first object within a duration of wake-up signal monitoring, or the terminal monitors the wake-up signal within a skipping duration of first object monitoring.

It may be understood that in the time interval allowed from a time when the terminal monitors the wake-up signal to a time when the terminal is able to monitor the first object, the terminal is in a state of not monitoring the first object when the terminal monitors the wake-up signal.

In some embodiments, the first object includes at least one of the following:
a first physical downlink control channel PDCCH;
a synchronization signal or a synchronization signal block (Synchronization Signal and PBCH block, SSB);
a Channel State Information Reference Signal (CSI-RS); or
a first Physical Downlink Shared Channel (PDSCH).

In an implementation, the first PDCCH is a PDCCH associated with a terminal-specific search space (UE-specific Search Space, USS) and/or a type 3 Common Search Space (CSS).

In an implementation, the SSB is an SSB used for Radio Resource Management (RRM) measurement.

In an implementation, the CSI-RS is a CSI-RS used for RRM measurement or channel measurement.

In an implementation, the first PDSCH is a Semi-Persistent Scheduling (SPS) PDSCH.

In some embodiments, the first indication information includes at least one of the following:
indication information of the first time interval;
indication information of an application time period of the first time interval; or
indication information of an application delay of the first time interval.

The indication information of the first time interval herein is used for indicating the value of the first time interval. The indication information of the application time period of the first time interval is used for indicating a time period for applying the first time interval. The indication information of the application delay of the first time interval is used for indicating an offset of the first time interval. The application delay may also be understood as an effective delay.

In an implementation, the first time interval acts on a process in which the terminal returns to a state (for example, a state that the monitoring of the PDCCH is skipped) in which the terminal does not monitor the first object to a state (a state of the monitoring of the PDCCH) in which the terminal monitors the first object. The terminal may monitor the wake-up signal within the time period for which the monitoring of the PDCCH is skipped.

For example, the first time interval indicated by the first indication information is 3 ms. In addition, the terminal monitors the wake-up signal during the time period for which the first object is not monitored (for example, within the time period for which the monitoring of the PDCCH is skipped). After the terminal receives the first indication information and determines that the first time interval is 3 ms, the terminal may enter the light sleep mode within the time period for which the monitoring of the PDCCH is skipped, to reduce power consumption. Subsequently, in a case that the terminal needs to return to a state in which the PDCCH (for example, the terminal monitors the wake-up signal or monitors the wake-up signal to instruct the terminal to return to a state in which the PDCCH is monitored) can be monitored, the terminal may return to a state from the light sleep mode to be able to monitor the PDCCH, and a conversion delay thereof is 3 ms, which meets a requirement of the indicated first time interval.

In some embodiments, a start time when the first time interval is applied includes at least one of the following:
an end time of a time unit where the first indication information is located;
a start time of a next time unit of the time unit where the first indication information is located; or
an end time of an application delay of the first time interval.

It may be understood that the start time at which the first time interval is applied may be understood as a valid start time of the first time interval.

In some embodiments, the start time of the first time interval may be another time, such as a default time. Details are not described herein again.

In some embodiments, the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

In some embodiments, the first indication information is carried by at least one of the following:
a Radio Resource Control (RRC) signaling;
Media Access Control Control Element (MACCE) signaling;
first Downlink control information (DCI); or
the wake-up signal.

An example in which the RRC signaling carries the first indication information is used. The network side device sends the RRC signaling carrying the first indication information to configure a value of the first time interval as 0 ms or 3 ms.

In some embodiments, the first DCI is at least one of the following:
DCI carrying a power saving indication (skipping indication), the power saving indication including: a PDCCH skipping indication and a search space group switching indication;
DCI with scheduling data transmission; or
DCI with non-scheduling data transmission.

In an embodiment, the network configures the first time interval indication and the monitoring of the PDCCH skipping indication are bound. The terminal also receives the first time interval indication information while receiving the monitoring of the PDCCH skipping indication.

In another embodiment, the network configures the first time interval information to be indicated by a PDCCH skipping indication field. For example, two code points in a PDCCH skipping indication bit are occupied to carry values of two different first time intervals.

In some embodiments, in a case that the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time, where
the wake-up process is a process from a time when the terminal does not monitor the first object to a time when the terminal is able to monitor the first object.

In other words, in a case that the terminal receives the wake-up signal and the wake-up signal further carries the first indication information, for the first time interval, the terminal does not expect to apply the first time interval in the wake-up process triggered by the received wake-up signal at this time, but applies a wake-up process after the wake-up process triggered by the received wake-up signal at this time to the first time interval, to a process in which the first object can be monitored when the terminal receives the wake-up signal at the next time.

Another carrying manner of the first indication information is not limited herein.

In addition, in some embodiments, the application time period of the first time interval includes at least one of the following:
an inactive period of Discontinuous Reception (DRX); or
a PDCCH skipping duration indicated by the DCI.

In an embodiment, the first time interval can only be applied in during a non-activation period (active time) of the DRX. Namely, the first time interval indication is not applied in the DRX active time. In other words, in the non-DRX active time, a time interval from a time when the wake-up signal is monitored by the terminal to a time when the terminal is able to monitor the first object, or a time interval from a time when the terminal determines to start monitoring the first object to a time when the terminal is able to monitor the first object is less than or equal to the first time interval indicated by the first indication information.

In some embodiments, a delay requirement for the terminal to return to a state from not monitoring the PDCCH state to be able to monitor the PDCCH state in DRX active time is configured by a network side or agreed on by a protocol.

In some embodiments, during the DRX active time,
the terminal can only apply a first specific value among values of the first time interval, or the terminal does not apply a second specific value among the values of the first time interval during the DRX active time.

The first specific value is different from the second specific value.

In an embodiment, the network configures or predefines that the terminal can only apply the first specific value in the values of the first time interval during the DRX active time, or the terminal does not apply the second specific value in the values of the first time interval during the DRX active time.

The first specific value may be understood as an optimal value applied to a time interval from a time when the wake-up signal is monitored to a time when the terminal is able to monitor the first object by the terminal during the DRX active time, or a time interval from a time when the terminal determines to start monitoring the first object to a time when the terminal is able to monitor the first object. The second specific value may be understood as a maximum time interval from a time when the wake-up signal is monitored to a time when the terminal is able to monitor the first object, or a maximum time interval from a time when the terminal determines to start monitoring the first object to a time when the terminal is able to monitor the first object.

In an embodiment, the network configures or predefines that the terminal can only apply two smallest values in the values of the first time interval during the DRX active time, for example, 0 and 3 ms. In other words, if the first time interval indicated by the first indication information (in this case, the first time interval represents the maximum time interval) is 10 ms, the terminal does not apply the first time interval of 10 ms during the DRX active time.

In another embodiment, the network configures or predefines that the terminal cannot apply the second specific value in the values of the first time interval during the DRX active time, for example, 3 ms (a maximum time interval allowed from a time when the terminal monitors the wake-up signal to a time when the terminal is able to monitor the first object). In other words, the time interval from a time when the terminal is allowed to monitor the wake-up signal to a time when the terminal can monitor the first object during the DRX active time cannot exceed 3 ms.

In some embodiments, the first time interval is applied to at least one of the following processes:
a process from a time when the terminal monitors the wake-up signal to a time when the terminal is able to monitor the first object;
a process from a time when the terminal determines to start monitoring the first object to a time when the terminal is able to monitor the first object; or
a process from a time when the terminal does not monitor the first object to a time when the terminal is able to monitor the first object.

In other words, for the foregoing one or more processes, the time interval between from a time when the terminal monitors the wake-up signal and to a time when the terminal can monitor the first object, or the time interval from a time when the terminal determines to start monitoring the first object to a time when the first object needs to be less than or equal to a value of the first time interval indicated by the first indication information.

In some embodiments, the wake-up signal is a low-power wake-up signal.

In other words, as shown in FIG. 2, the low-power wake-up signal is received by the low-power receiving module (the power receiver). The low power receiver is different from a main receiver that receives the NR channel signal.

The application of embodiments of this application is described below by using an XR service transmission scenario as an example.

To achieve power saving of the terminal without affecting or slightly affecting system capacity, in a case that a quantity of XR terminals carried by the network is relatively small (that is, a case that the system is under a light load), due to sufficient network scheduling resources, the terminal may be instructed to relax for the first time interval to some extent in exchange for a greater power saving gain of the terminal on the premise that a transmission requirement for an XR service is met (for example, a packet delay budget of 10 ms for an XR time-frequency service is met). For example, if the network side device instructs, through the first indication information, the terminal to switch the first time interval to 3 ms, within a time period for which the PDCCH is not monitored subsequently, the terminal may enter light sleep (needing a conversion delay of 3 ms), thereby obtaining a greater power-saving gain than entering micro sleep. If the network load increases subsequently, to ensure transmission of the XR service, the network side device may instruct the first time interval to be updated to 0 ms in time through the first indication information, and then the terminal can enter only the micro sleep during a time period for which the PDCCH is not monitored subsequently, thereby realizing quick returning to a state in which the PDCCH state (a state in which the PDCCH can be monitored) is monitored and data scheduling of a network is monitored in time in a case that the state in which the PDCCH is monitored needs to be returned.

During transmission of the XR service, due to a presence of jitter in the XR service, the service may arrive within an entire jitter range. To meet strict PDB requirements of the XR service, a solution is to cope with the jitter by monitoring a Low-power wake-up signal (LP-WUS) instead of monitoring the PDCCH within the jitter range. However, within the time period for which the monitoring of the PDCCH is skipped, the terminal may enter different sleep states through implementation, but needs a longer delay for returning to a state in which the PDCCH is monitored in a deeper sleep state. Since it is unclear how the delay caused by sleep affects the system capacity, the terminal cannot determine which state to enter.

It is proved through analysis of simulation results that in a case that the network carries a relatively small quantity of XR terminals (that is, a case that the system is under a light load), the terminal enters a deeper sleep state, and can still meet the transmission requirement of the XR service.

However, in a current standard, the network is not allowed to adjust, based on a load condition, a sleep state (which means entering the micro sleep or the light sleep) of the terminal in a state of skipping the monitoring of the PDCCH.

In the present disclosure, the first time interval is indicated through the network, so that the terminal adjusts a power-saving state in time, thereby implementing adaptive power saving.

Based on the above, according to the method in embodiments of the present application, the first time interval (a time interval allowed from a time when the wake-up signal is monitored to a time when the terminal is able to monitor the first object; or a time interval allowed from a time when the monitoring of the first object is determined to start to a time when the terminal is able to monitor the first object) is indicated, so that the terminal can be more flexibly enabled to achieve different degrees of power saving.

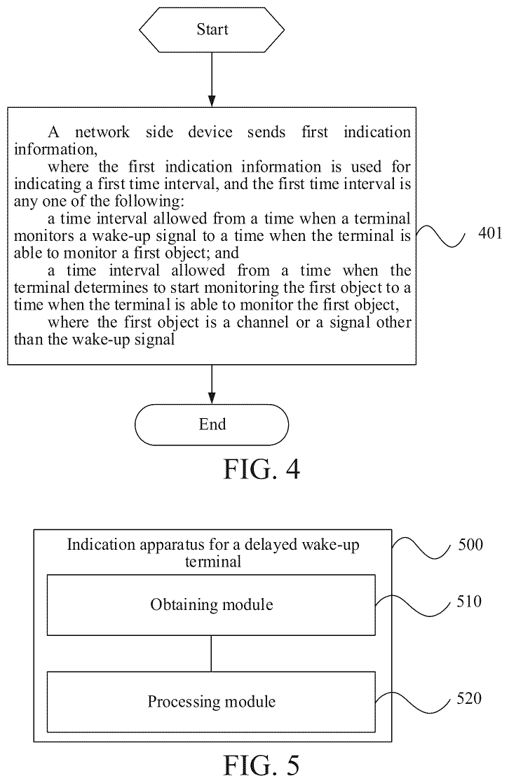

As shown in FIG. 4, an indication method for a delayed wake-up terminal in an embodiment of this application includes the following steps.

Step 401: A network side device sends first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

In this way, the network side device can send the first indication information to the terminal, so that the terminal determines the first time interval. In this way, the terminal can subsequently implement adaptive power saving of the terminal based on a value of the first time interval. For example, when the first object is a PDCCH, after the wake-up signal is monitored or it is determined that monitoring the first object is started, the PDCCH can be monitored through adjustment in time based on the value of the first time interval.

In some embodiments, the wake-up signal is used for triggering the terminal to start monitoring the first object, or the wake-up signal is used for indicating whether the terminal starts monitoring the first object.

In some embodiments, the first indication information includes at least one of the following:
indication information of the first time interval;
indication information of an application time period of the first time interval; or
indication information of an application delay of the first time interval.

In some embodiments, the application time period of the first time interval includes at least one of the following:
outside discontinuous reception (DRX) active time; or
a physical downlink control channel (PDCCH) skipping duration indicated by downlink control information (DCI).

In some embodiments, during the DRX active time,
the terminal applies a first specific value among values of the first time interval, or the terminal does not apply a second specific value among the values of the first time interval, where

The first specific value is different from the second specific value.

In some embodiments, the first time interval is applied to at least one of the following processes:
a process from a time when the terminal monitors the wake-up signal to a time when the terminal is able to monitor the first object;
a process from a time when the terminal determines to start monitoring the first object to a time when the terminal is able to monitor the first object; or
a process from a time when the terminal does not monitor the first object to a time when the terminal is able to monitor the first object.

In some embodiments, a start time when the first time interval is applied includes at least one of the following:
an end time of a time unit where the first indication information is located;
a start time of a next time unit of the time unit where the first indication information is located; or
an end time of an application delay of the first time interval.

In some embodiments, in a case that the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time, where
the wake-up process is a process from a time when the terminal does not monitor the first object to a time when the terminal is able to monitor the first object.

In some embodiments, the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

In some embodiments, values of the first time interval include at least two of a first value, a second value, and a third value, and the first value, the second value, and the third value are all different.

In some embodiments, the first object includes at least one of the following:
a first PDCCH;
a synchronization signal or a synchronization signal block (SSB);
a channel state information reference signal (CSI-RS); or
a first physical downlink shared channel (PDSCH).

In some embodiments, the first indication information is carried by at least one of the following:
radio resource control RRC signaling;
medium access control control element MACCE signaling;
first DCI; or
the wake-up signal.

In some embodiments, the first DCI is at least one of the following:
DCI carrying a power saving indication, where the power saving indication includes: a PDCCH skipping indication and a search space group switching indication;
DCI with scheduling data transmission; or
DCI with non-scheduling data transmission.

In some embodiments, the wake-up signal is a low-power wake-up signal.

It should be noted that the method is implemented in cooperation with the foregoing indication method for a delayed wake-up terminal performed by the terminal. The implementation of the foregoing embodiment of the indication method for a delayed wake-up terminal performed by the terminal is applicable to the method, and the same technical effect can also be achieved.

An execution body of the indication method for a delayed wake-up terminal provided in embodiments of this application may be an indication apparatus for a delayed wake-up terminal. In embodiments of this application, the indication apparatus for a delayed wake-up terminal provided in embodiments of this application is described by using an example in which the indication apparatus for a delayed wake-up terminal performs the indication method for a delayed wake-up terminal.

As shown in FIG. 5, an indication apparatus 500 for a delayed wake-up terminal in an embodiment of this application includes:
an obtaining module 510, configured to obtain first indication information; and
a processing module 520, configured to determine a first time interval based on the first indication information, where
the first time interval is any one of the following:
a time interval allowed from a time when a terminal monitors a wake-up signal to a time when the terminal is able to monitor a first object; or
a time interval allowed from a time when the terminal starts monitoring the first object to a time when the terminal is able to monitor the first object, where
the first object is a channel or a signal other than the wake-up signal.

In some embodiments, the wake-up signal is used for triggering the terminal to start monitoring the first object, or the wake-up signal is used for indicating whether the terminal starts monitoring the first object.

In some embodiments, the terminal does not monitor the first object within a duration of wake-up signal monitoring, or the terminal monitors the wake-up signal within the skipping duration of first object monitoring.

In some embodiments, the first indication information includes at least one of the following:
indication information of the first time interval;
indication information of an application time period of the first time interval; or
indication information of an application delay of the first time interval.

In some embodiments, the application time period of the first time interval includes at least one of the following:
outside discontinuous reception DRX active time; or
a physical downlink control channel PDCCH skipping duration indicated by downlink control information DCI.

In some embodiments, during the DRX active time,
the terminal applies a first specific value among values of the first time interval, or the terminal does not apply a second specific value among the values of the first time interval, where
the first specific value is different from the second specific value.

In some embodiments, the apparatus further includes:
a determining module, configured to determine, based on the first time interval, a power-saving mode which the terminal enters during the skipping duration of first object monitoring, where the power-saving mode is related to power consumption of the terminal.

In some embodiments, the first time interval is applied to at least one of the following processes:
a process from a time when the terminal monitors the wake-up signal to a time when the terminal is able to monitor the first object;
a process from a time when the terminal determines to start monitoring the first object to a time when the terminal is able to monitor the first object; or
a process from a time when the terminal does not monitor the first object to a time when the terminal is able to monitor the first object.

In some embodiments, a start time when the first time interval is applied includes at least one of the following:
an end time of a time unit where the first indication information is located;
a start time of a next time unit of the time unit where the first indication information is located; or
an end time of an application delay of the first time interval.

In some embodiments, in a case that the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time, where
the wake-up process is a process from a time when the terminal does not monitor the first object to a time when the terminal is able to monitor the first object.

In some embodiments, the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

In some embodiments, values of the first time interval include at least two of a first value, a second value, and a third value, and the first value, the second value, and the third value are all different.

In some embodiments, the first object includes at least one of the following:
a first PDCCH;
a synchronization signal or a synchronization signal block SSB;
a channel state information reference signal CSI-RS; or
a first physical downlink shared channel PDSCH.

In some embodiments, the first indication information is carried by at least one of the following:
radio resource control RRC signaling;
medium access control control element MACCE signaling;
first DCI; or
the wake-up signal.

In some embodiments, the first DCI is at least one of the following:
DCI carrying a power saving indication, where the power saving indication includes: a PDCCH skipping indication and a search space group switching indication;
DCI with scheduling data transmission; or
DCI with non-scheduling data transmission.

In some embodiments, the wake-up signal is a low-power wake-up signal.

The apparatus indicates the first time interval (the time interval allowed from a time when the wake-up signal is monitored to a time when the terminal is able to monitor the first object; or a time interval allowed from a time when it is determined that monitoring the first object is started to a time when the terminal is able to monitor the first object), so that the terminal implements adaptive power saving based on the first time interval.

The apparatus in embodiments of this application may be an electronic device, for example, an electronic device having an operating system, or a component in an electronic device, such as an integrated circuit or a chip. The electronic device may be a terminal, or may be another device other than the terminal. For example, the terminal may include but is not limited to the above listed types of the terminal 11, and the another device may be a server, a Network Attached Storage (NAS), or the like. This is not specifically limited in this embodiment of this application.

The apparatus provided in embodiments of this application can implement the processes implemented in the method embodiment of FIG. 3, and achieve a same technical effect. To avoid repetition, details are not described herein again.

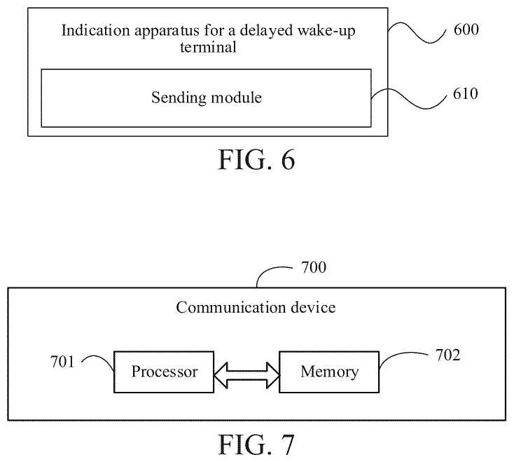

As shown in FIG. 6, an indication apparatus 600 for a delayed wake-up terminal in an embodiment of this application includes:
a sending module 610, configured to send first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

In some embodiments, the wake-up signal is used for triggering the terminal to start monitoring the first object, or the wake-up signal is used for indicating whether the terminal starts monitoring the first object.

In some embodiments, the first indication information includes at least one of the following:
indication information of the first time interval;
indication information of an application time period of the first time interval; or
indication information of an application delay of the first time interval.

In some embodiments, the application time period of the first time interval includes at least one of the following:
outside discontinuous reception DRX active time; or
a physical downlink control channel PDCCH skipping duration indicated by downlink control information DCI.

In some embodiments, during the DRX active time,
the terminal applies a first specific value among values of the first time interval, or the terminal does not apply a second specific value among the values of the first time interval, where
the first specific value is different from the second specific value.

In some embodiments, the first time interval is applied to at least one of the following processes:
a process from a time when the terminal monitors the wake-up signal to a time when the terminal is able to monitor the first object; a process from a time when the terminal determines to start monitoring the first object to a time when the terminal is able to monitor the first object; or a process from a time when the terminal does not monitor the first object to a time when the terminal is able to monitor the first object.

In some embodiments, a start time when the first time interval is applied includes at least one of the following:
an end time of a time unit where the first indication information is located;
a start time of a next time unit of the time unit where the first indication information is located; or
an end time of an application delay of the first time interval.

In some embodiments, in a case that the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time, where
the wake-up process is a process from a time when the terminal does not monitor the first object to a time when the terminal is able to monitor the first object.

In some embodiments, the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

In some embodiments, a value of the first time interval is configured or predefined by a network side.

In some embodiments, values of the first time interval include a first value and a second value, and the first value is different from the second value.

In some embodiments, the first object includes at least one of the following:
a first PDCCH;
a synchronization signal or a synchronization signal block SSB;
a channel state information reference signal CSI-RS; or
a first physical downlink shared channel PDSCH.

In some embodiments, the first indication information is carried by at least one of the following:
radio resource control RRC signaling;
medium access control control element MACCE signaling;
first DCI; or
the wake-up signal.

In some embodiments, the first DCI is at least one of the following:
DCI carrying a power saving indication, where the power saving indication includes: a PDCCH skipping indication and a search space group switching indication;
DCI with scheduling data transmission; or
DCI with non-scheduling data transmission.

In some embodiments, the wake-up signal is a low-power wake-up signal.

The apparatus provided in embodiments of this application can implement the processes implemented in the method embodiment of FIG. 4, and achieve a same technical effect. To avoid repetition, details are not described herein again.

As shown in FIG. 7, an embodiment of this application further provides a communication device 700, including a processor 701 and a memory 702. The memory 702 stores program or an instruction executable on the processor 701. For example, when the communication device 700 is a terminal, the program, or the instruction, when executed by the processor 701, implements the steps in the foregoing embodiments of the indication method for a delayed wake-up terminal, and can achieve the same technical effects. When the communication device 700 is a network side device, the program or the instruction, when executed by the processor 701, implements the steps of the foregoing embodiment of the indication method for a delayed wake-up terminal performed by the network side device, and can achieve the same technical effects. To avoid repetition, details are not described herein again.

An embodiment of this application further provides a terminal, including a processor and a communication interface. The communication interface is configured to obtain first indication information. The processor is configured to determine a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

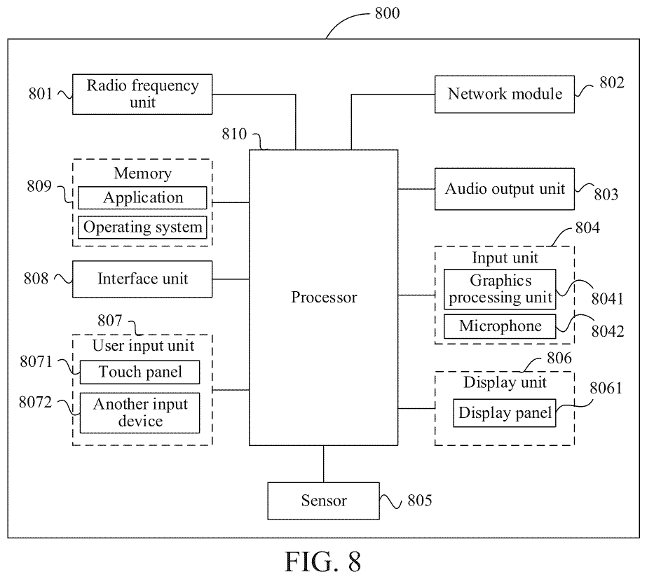

The terminal embodiment corresponds to the foregoing terminal side method embodiment. The implementation processes and implementations of the foregoing method embodiment are all applicable to the terminal embodiment, and can achieve the same technical effect. FIG. 8 is a schematic diagram of a hardware structure of a terminal for implementing an embodiment of this application.

A terminal 800 includes but is not limited to at least some of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (for example, a battery) that supplies power to the components. The power supply may be logically connected to the processor 810 through a power management system, thereby implementing functions such as management of charging, discharging, and power consumption through the power management system. The terminal structure shown in FIG. 8 constitutes no limitation on the terminal, and the terminal may include more or fewer components than those shown in the figure, or some merged components, or different component arrangements. Details are not described herein again.

It should be noted that, in this embodiment of this application, the input unit 804 may include a Graphics Processing Unit (GPU) 8041 and a microphone 8042. The graphics processing unit 8041 processes image data of a static picture or a video obtained by an image capturing apparatus (for example, a camera) in a video capturing mode or an image capturing mode. The display unit 806 may include a display panel 8061. The display panel 8061 may be configured in a form such as a liquid crystal display or an organic light-emitting diode. The user input unit 807 includes at least one of a touch panel 8071 or another input device 8072. The touch panel 8071 is also referred to as a touch screen. The touch panel 8071 may include two parts: a touch detection apparatus and a touch controller. The another input device 8072 may include but is not limited to a physical keyboard, a function button (such as a volume control button or a power button), a trackball, a mouse, and a joystick. Details are not described herein.

In this embodiment of this application, the radio frequency unit 801 receives downlink data from a network side device, and then may send the data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may include mainly a first storage area for storing a program or instructions and a second storage area for storing data. The first storage area may store an operating system, an application or an instruction required for at least one function (such as a sound playback function and an image playback function), and the like. In addition, the memory 809 may include a volatile memory or a non-volatile memory, or the memory 809 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 809 in this embodiment of this application includes but is not limited to the above and any other suitable types of memories.

The processor 810 may include one or more processing units. In some embodiments, the processor 810 integrates an application processor and a modem processor. The application processor mainly processes operations related to an operating system, a user interface, an application, and the like. The modem processor mainly processes a wireless communication signal, for example, may be a baseband processor. It may be understood that the foregoing modem processor may not be integrated into the processor 810.

The radio frequency unit 801 is configured to obtain first indication information.

The processor 810 is configured to determine a first time interval based on the first indication information, where
the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

The terminal can determine the first time interval by obtaining the first indication information, so that the terminal implements adaptive power saving of the terminal based on a value of the first time interval.

In some embodiments, the wake-up signal is used for triggering the terminal to start monitoring the first object, or the wake-up signal is used for indicating whether the terminal starts monitoring the first object.

In some embodiments, the terminal does not monitor the first object within a duration of wake-up signal monitoring, or the terminal monitors the wake-up signal within the skipping duration of first object monitoring.

In some embodiments, the first indication information includes at least one of the following:
indication information of the first time interval;
indication information of an application time period of the first time interval; or
indication information of an application delay of the first time interval.

In some embodiments, the application time period of the first time interval includes at least one of the following:
outside discontinuous reception DRX active time; or
a physical downlink control channel PDCCH skipping duration indicated by downlink control information DCI.

In some embodiments, during the DRX active time,
the terminal applies a first specific value among values of the first time interval, or the terminal does not apply a second specific value among the values of the first time interval, where
the first specific value is different from the second specific value.

In some embodiments, the processor 810 is further configured to:
determine, based on the first time interval, a power-saving mode which the terminal enters during the skipping duration of first object monitoring, where the power-saving mode is related to power consumption of the terminal.

In some embodiments, the first time interval is applied to at least one of the following processes:
a process from a time when the terminal monitors the wake-up signal to a time when the terminal is able to monitor the first object, or a process from a time when the terminal determines to start monitoring the first object to a time when the terminal is able to monitor the first object, or a process from a time when the terminal does not monitor the first object to a time when the terminal is able to monitor the first object.

In some embodiments, a start time when the first time interval is applied includes at least one of the following:
an end time of a time unit where the first indication information is located;
a start time of a next time unit of the time unit where the first indication information is located; or
an end time of an application delay of the first time interval.

In some embodiments, in a case that the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time, where
the wake-up process is a process from a time when the terminal does not monitor the first object to a time when the terminal is able to monitor the first object.

In some embodiments, the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

In some embodiments, values of the first time interval include at least two of a first value, a second value, and a third value, and the first value, the second value, and the third value are all different.

In some embodiments, the first object includes at least one of the following:
a first PDCCH;
a synchronization signal or a synchronization signal block SSB;
a channel state information reference signal CSI-RS; or
a first physical downlink shared channel PDSCH.

In some embodiments, the first indication information is carried by at least one of the following:
radio resource control RRC signaling;
medium access control control element MACCE signaling;
first DCI; or
the wake-up signal.

In some embodiments, the first DCI is at least one of the following:
DCI carrying a power saving indication, where the power saving indication includes: a PDCCH skipping indication and a search space group switching indication;
DCI with scheduling data transmission; or
DCI with non-scheduling data transmission.

In some embodiments, the wake-up signal is a low-power wake-up signal.

An embodiment of this application further provides a network side device, including a processor and a communication interface. The communication interface is configured to send first indication information, where the first indication information is used for indicating a first time interval, and
the first time interval is any one of the following:
a time interval allowed from a time when a terminal monitors a wake-up signal to a time when the terminal is able to monitor a first object; or
a time interval allowed from a time when the terminal determines to start monitoring the first object to a time when the terminal is able to monitor the first object, where
the first object is a channel or a signal other than the wake-up signal.

The network side device embodiment corresponds to the foregoing method embodiment of the network side device. The implementation processes and implementations of the foregoing method embodiment are all applicable to the embodiment of the network side device, and can achieve the same technical effect.

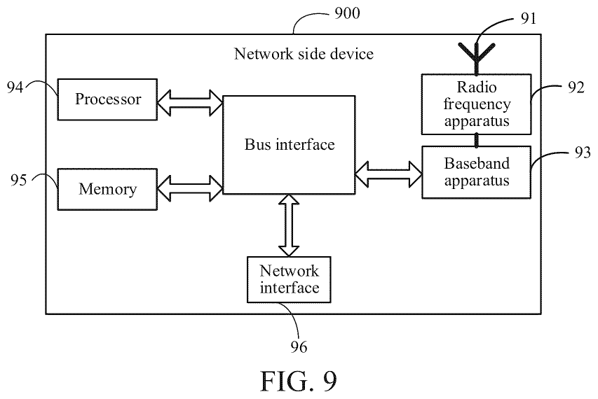

An embodiment of this application further provides a network side device. As shown in FIG. 9, the network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes to-be-sent information and sends the to-be-sent information to the radio frequency apparatus 92. The radio frequency apparatus 92 processes the received information and then sends the information through the antenna 91.

The method performed by the network side device in the foregoing embodiment may be implemented by the baseband apparatus 93. The baseband apparatus 93 includes a baseband processor.

The baseband apparatus 93 may include, for example, at least one baseband board. A plurality of chips are arranged on the baseband board, as shown in FIG. 9. One of the chips is, for example, a baseband processor, and is connected to the memory 95 through a bus interface to call a program in the memory 95, to perform the operations of the network device shown in the foregoing method embodiment.

The network side device may further include a network interface 96. The interface is, for example, a common public radio interface (CPRI).

The network side device 900 in embodiments of this application further includes an instruction or a program stored in the memory 95 and executable on the processor 94. The processor 94 calls the instruction or the program in the memory 95 to perform the method performed by each module shown in FIG. 6, and achieves the same technical effects. To avoid repetition, details are not described herein.

An embodiment of this application further provides a readable storage medium. The readable storage medium stores a program or an instruction. The program or the instruction, when executed by a processor, implements the indication method for a delayed wake-up terminal performed by the terminal, or implements processes of the foregoing embodiment of the indication method for a delayed wake-up terminal performed by the network side device, and can achieve the same technical effects. To avoid repetition, details are not described herein again.

The processor may be a processor of the terminal in foregoing embodiments. The readable storage medium includes a computer-readable storage medium, such as a computer Read-Only Memory (ROM), a Random Access Memory (RAM), a magnetic disk, or an optical disk.

An embodiment of this application further provides a chip. The chip includes a processor and a communication interface. The communication interface is coupled to the processor. The processor is configured to run a program or an instruction, to implement the indication method for a delayed wake-up terminal performed by the terminal, or implement processes of the foregoing embodiment of the indication method for a delayed wake-up terminal performed by the network side device, and can achieve the same technical effects. To avoid repetition, details are not described herein again.

It should be understood that the chip in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the indication method for a delayed wake-up terminal performed by the terminal, or implement processes of the foregoing embodiment of the indication method for a delayed wake-up terminal performed by the network side device, and can achieve the same technical effects. To avoid repetition, details are not described herein again.

An embodiment of this application further provides an indication system for a delayed wake-up terminal, including a terminal and a network side device. The terminal may be configured to perform steps of the foregoing indication method for a delayed wake-up terminal, and the network side device may be configured to perform steps of the foregoing indication method for a delayed wake-up terminal performed by the network side device.

It should be noted that terms “comprise”, “include” or any other variants herein are intended to encompass non-exclusive inclusion, so that a process, a method, an article, or an apparatus including a series of elements not only include those elements, but also includes another element not listed explicitly or includes intrinsic elements for the process, the method, the article, or the apparatus. Without any further limitation, an element defined by a phrase “include one . . . ” does not exclude existence of an additional same element in the process, the method, the article, or the apparatus that includes the element. In addition, it should be noted that the scope of the method and the apparatus in implementations of this application is not limited to function execution in the order shown or discussed, and may further include function execution in a substantially simultaneous manner or in the opposite order based on the functions. For example, the described method may be performed in different order from the described order, and various steps may also be added, omitted, or combined. In addition, features described with reference to some examples may be combined in another example.

According to the descriptions of the foregoing implementations, a person skilled in the art may clearly learn that the method in the foregoing embodiments may be implemented by software with a necessary universal hardware platform, or may be implemented by hardware. Based on such an understanding, the technical solutions of this application, in essence, or a part contributing to the prior art may be embodied in a form of a computer software product. The computer software product is stored in a storage medium (such as a ROM/RAM, a magnetic disk, or an optical disk), including a plurality of instructions for causing a terminal (which may be a mobile phone, a computer, a server, an air conditioner, a network device, or the like) to perform the methods in embodiments of this application.

Although embodiments of this application are described above with reference to the drawings, this application is not limited to the specific implementations described above. The foregoing specific implementations are illustrative but not restrictive. With the enlightenment of this application, a person of ordinary skill in the art may make many forms without departing from the concept of this application and the protection scope of the claims. These forms fall within the protection of this application.

What is claimed is:

1. An indication method for a delayed wake-up terminal, comprising:
obtaining, by a terminal, first indication information; and
determining, by the terminal, a first time interval based on the first indication information, wherein the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object,
wherein the first object is a channel or a signal other than the wake-up signal.

2. The indication method according to claim 1, wherein the wake-up signal is used for triggering the terminal to start monitoring the first object, or the wake-up signal is used for indicating whether the terminal starts monitoring the first object.

3. The indication method according to claim 1, wherein the terminal does not monitor the first object within a duration of wake-up signal monitoring, or the terminal monitors the wake-up signal within a skipping duration of first object monitoring.

4. The indication method according to claim 1, wherein the first indication information comprises at least one of the following:
indication information of the first time interval;
indication information of an application time period of the first time interval; or
indication information of an application delay of the first time interval.

5. The indication method according to claim 4, wherein the application time period of the first time interval comprises at least one of the following:
outside discontinuous reception (DRX) active time; and
a physical downlink control channel (PDCCH) skipping duration indicated by downlink control information (DCI).

6. The indication method according to claim 1, wherein during the DRX active time,
the terminal applies a first specific value among values of the first time interval, or the terminal does not apply a second specific value among the values of the first time interval,
wherein the first specific value is different from the second specific value.

7. The indication method according to claim 1, further comprising:
determining, by the terminal based on the first time interval, a power-saving mode which the terminal enters during a skipping duration of first object monitoring, wherein the power-saving mode is related to power consumption of the terminal.

8. The indication method according to claim 1, wherein the first time interval is applied to at least one of the following processes:
a process from a time when the terminal monitors the wake-up signal to a time when the terminal is able to monitor the first object;
a process from a time when the terminal determines to start monitoring the first object to a time when the terminal is able to monitor the first object; or
a process from a time when the terminal does not monitor the first object to a time when the terminal is able to monitor the first object.

9. The indication method according to claim 1, wherein a start time when the first time interval is applied comprises at least one of the following:
an end time of a time unit where the first indication information is located;
a start time of a next time unit of the time unit where the first indication information is located; or
an end time of an application delay of the first time interval.

10. The indication method according to claim 1, wherein when the terminal receives the first indication information carried by the wake-up signal,
the first time interval is not applied to a wake-up process triggered by the wake-up signal received at this time; or
the first time interval is applied to a wake-up process after the wake-up process triggered by the wake-up signal received at this time,
wherein the wake-up process is a process from a time when the terminal does not monitor the first object to a time when the terminal is able to monitor the first object.

11. The indication method according to claim 4, wherein the application delay of the first time interval is one of the following:
a time interval between the end time of the time unit where the first indication information is located and the start time when the first time interval is applied; or
a time interval between the start time of the next time unit of the time unit where the first indication information is located and the start time when the first time interval is applied.

12. The indication method according to claim 1, wherein values of the first time interval comprise at least two of a first value, a second value, or a third value, and the first value, the second value, and the third value are all different.

13. The indication method according to claim 1, wherein the first object comprises at least one of the following:
a first physical downlink control channel (PDCCH);
a synchronization signal or a synchronization signal block (SSB);
a channel state information reference signal (CSI-RS); or
a first physical downlink shared channel (PDSCH).

14. The indication method according to claim 1, wherein the first indication information is carried by at least one of the following:
radio resource control (RRC) signaling;
medium access control control element (MACCE) signaling;
first downlink control information (DCI); or
the wake-up signal.

15. An indication method for a delayed wake-up terminal, comprising:
sending, by a network side device, first indication information, wherein the first indication information is used for indicating a first time interval, and
the first time interval is any one of the following:
a time interval allowed from a time when a terminal monitors a wake-up signal to a time when the terminal is able to monitor a first object; and
a time interval allowed from a time when the terminal determines to start monitoring the first object to a time when the terminal is able to monitor the first object, wherein
the first object is a channel or a signal other than the wake-up signal.

16. The method according to claim 15, wherein the first indication information comprises at least one of the following:
indication information of the first time interval;
indication information of an application time period of the first time interval; or
indication information of an application delay of the first time interval.

17. The method according to claim 16, wherein the first indication information is carried by at least one of the following:
radio resource control (RRC) signaling;
medium access control control element (MACCE) signaling;
first downlink control information (DCI); or
the wake-up signal.

18. A terminal, comprising a processor and a memory storing a program or an instruction that is capable of running on the processor, wherein the program or the instruction, when executed by the processor, causes the terminal to perform:
obtaining first indication information; and
determining a first time interval based on the first indication information, wherein the first time interval is any one of the following:
a time interval allowed from a time when the terminal monitors a wake-up signal to a time when the terminal is able to monitor a first object; or
a time interval allowed from a time when the terminal determines to start monitoring the first object to a time when the terminal is able to monitor the first object,
wherein the first object is a channel or a signal other than the wake-up signal.

19. The terminal according to claim 18, wherein the wake-up signal is used for triggering the terminal to start monitoring the first object, or the wake-up signal is used for indicating whether the terminal starts monitoring the first object.

20. The terminal according to claim 18, wherein the terminal does not monitor the first object within a duration of wake-up signal monitoring, or the terminal monitors the wake-up signal within a skipping duration of first object monitoring.
